(19) United States
(12) Patent Application Publication
(10) Pub. No.: US 2019/0205014 A1
(43) Pub. Date: Jul. 4, 2019

(54) CUSTOMIZABLE CONTENT SHARING WITH INTELLIGENT TEXT SEGMENTATION

(71) Applicant: MICROSOFT TECHNOLOGY LICENSING, LLC, Redmond, WA (US)

(72) Inventors: Lei SUN, Redmond, WA (US); Yumao LU, Redmond, WA (US); Ling LI, Redmond, WA (US); Chen LIAO, Redmond, WA (US)

(73) Assignee: MICROSOFT TECHNOLOGY LICENSING, LLC, Redmond, WA (US)

(21) Appl. No.: 16/329,155

(22) PCT Filed: Aug. 23, 2017
(86) PCT No.: PCT/US2017/048095

§ 371 Date: Feb. 27, 2019

(30) Foreign Application Priority Data
Aug. 31, 2016 (CN) 201610784001.9

(51) Int. Cl. G06F 3/0484; G06F 17/21; G06F 17/24; G06F 3/0488

(52) U.S. Cl. CPC G06F 3/04842; G06F 3/04883; G06F 17/24; G06F 17/212

(57) ABSTRACT

Aspects of the present disclosure relate to systems and methods for sharing content. More specifically, a user may select a subset of content from displayed content. The selection may be made using a visual indicator. Once the subset of content is selected, the subset of content is analyzed to determine how much content of the subset of content the user wants to share. Once the determination is complete, a content card containing the subset of content is generated and provided to the user. The user may then add additional content to the content card and electronically share the content card by posting the content card on a social media site.

### BACKGROUND

Many content providers, such as, for example news aggregations sites, social media sites and so on, enable users to share content with other users. Traditionally, when content, such as a news article, is shared on a social media site, the uniform resource locator (URL) is presented for display on the particular site. In some instances, an automatically generated image caption or an article title may also be displayed. However, display of the image caption or the article title may be automatically selected and not reflect a portion of the content that the user is interested in sharing.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to systems and methods for sharing content. More specifically, the described embodiments enable a user to select a subset of content from displayed content and share it with others on a social media account or via some other electronic medium. In order to share the subset of content, a user may select, using a visual indicator, which portion of the displayed content she wants to share. Once the content is identified, a content card containing the identified content is created. The user may then add additional content, such as a personalized message, to the content card. The content card may then be provided to a social media account or may otherwise be electronically transmitted to another individual or site.

Accordingly, described herein is a method for sharing content. The method includes receiving input for selecting a subset of content from displayed content and displaying a visual indicator representing the selection of the subset of content. Once the visual indicator has been displayed, a determination is made, based on one or more rules associated with the visual indicator, an amount of content, from the subset of content, that is to be shared. An output that includes the amount of content is then generated and a user interface is provided that enables additional content to be added to the output. A determination is then made, based on a received input, whether the output will be electronically shared in a first medium or a second medium. The output is provided to the first medium when a first input is received and is provided to the second medium when a second input is received.

Also described is a system comprising a processor and a memory. The memory stores instructions that when executed by the processor, performs a method for displaying content. The method includes detecting a selection of content, displaying a visual indicator associated with the selected content, and determining a starting point of the selected content and an ending point of the selected content based, at least in part, on the visual indicator. Once the starting point and the ending point of the selected content have been determined, the selected content is prepared for display.

The present disclosure also describes a computer-readable storage medium comprising computer-executable instructions which, when executed by a processor, performs a method for sharing content. This method includes displaying content on a display of an electronic device, determining a region of interest of the content based, at least in part, on a detected input, and determining, based at least in part, on the region of interest, content that is to be shared. Once the determination has been made, a content card having the shared content is generated. The method also enables additional content to be added to the content card and also enables the content card to be shared.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example electronic device that may be used to provide and share content.

FIG. 2 illustrates the example electronic device of FIG. 1 in which a subset of content of the displayed content is selected or otherwise identified.

FIG. 3 illustrates the example electronic device of FIG. 1 in which a content card containing the subset of content is generated and displayed and also shows a user interface that enables additional content to be added to the content card.

FIG. 4 illustrates the example electronic device of FIG. 1 in which additional content has been added to the content card.

FIG. 5 shows an example scenario of how the content card generated in FIG. 4 can be electronically shared.

FIG. 6 illustrates example components of an electronic device that may be used to share selected content.

FIG. 7 illustrates an example method for sharing content.

FIG. 8 illustrates example physical components of an electronic device with which aspects of the disclosure may be practiced.

FIG. 9A illustrates an example electronic device with which aspects of the present disclosure may be practiced.

FIG. 9B is a block diagram that illustrates example components of the electronic device of FIG. 9A.

FIG. 10 is a block diagram of a distributed computing system in which aspects of the present disclosure may be practiced.

FIG. 11 illustrates another example electronic device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

Embodiments of the present disclosure are directed to enabling users to share content. More specifically, embodiments of the present disclosure are directed to enabling a user to select a subset of content from displayed content and add additional content, such as, for example, a personalized message that may be associated with the content, to the subset of content. Once the subset of content has been selected and the additional content has been added, the subset of content and the additional content may be electronically shared. In some instances, the subset of the content and the additional content may be provided on a content card. The content card may then be electronically transmitted or otherwise communicated to another individual. For example, the content card, or the content contained in the content card, may be posted to a social media site, transmitted via electronic message, and the like.

As will be explained below, the content to be shared may be any type of content that may be displayed on an electronic device. This content includes, but is not limited to, text content (e.g., news articles, books, sports stories etc.) pictures or other images, video content and so on.

Once the content is displayed on the electronic device, a user may select or otherwise indicate a subset or portion of the content she wants to share using a visual indicator. The text contained within and surrounding the visual indicator is analyzed to determine which portions of the text the user wants to share.

For example, in some instances, a user may circle a particular subset of content she wants to share. However, the circle may surround or partially surround words, phrases or sentences that the user does not wish to share. Accordingly, the methods described herein analyze the selected content to determine which portions of the subset of content are meant for sharing and which portions of the text should be omitted.

Once this determination has been made, the subset of content is provided on a content card and shown to the user. The user may edit the subset of content and/or add additional content to the content card. The content card may then be electronically shared. In some instances, the content card may be electronically shared by posting the content card on a social media site. In other implementations, the content card may be sent to a recipient via an electronic message (e.g., email, text, chat or other forms of electronic communication).

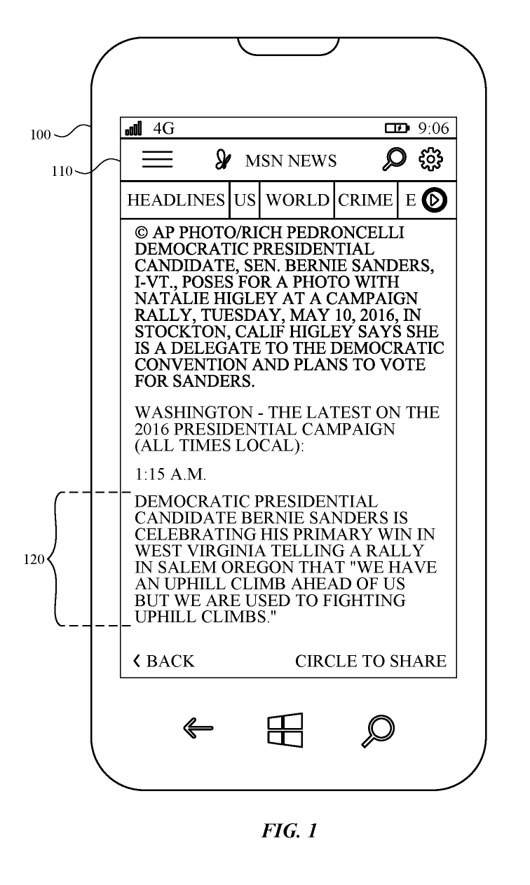

These and other embodiments will be described in more detail below with respect to FIGS. 1-11.

FIG. 1 illustrates an example electronic device 100 that may use the various embodiments of the present disclosure. As shown, the electronic device 100 may be a mobile phone having a display 110 on which content 120 is provided. Although a mobile telephone is shown and described, the electronic device 100 may be a tablet computer, a desktop computer, a laptop computer or any other electronic device capable of displaying content 120.

In some embodiments, the electronic device 100 utilizes a content aggregation application that gathers content from one source or a variety of sources and provides it on the display 110. The content may be text content, video content, image content or a combination thereof. The content aggregation application may also include a user interface that enables a user to select and share subsets of content such as described herein.

For example, the display 110 may be a touch sensitive display and/or a force sensitive display 110 that enables a user to provide input to the surface of the display 110 and select a subset of displayed content 120 the user wants to share. Although a touch sensitive display is mentioned, other input devices may be used to select content. For example, input may be provided to the electronic device 100 by a trackpad, a mouse, a button, a dial, a switch and so on.

As previously described, a user may wish to share the displayed content 120, or a portion of the displayed content 120, with another individual. For example, the user may wish to post a particular news article on her social media account. However, instead of posting the entire article, the user may wish to highlight a particular portion of the displayed content 120. Accordingly, embodiments of the present disclosure enable a user to provide input directly on the display 110 to select the portion of content 120 she wants to share.

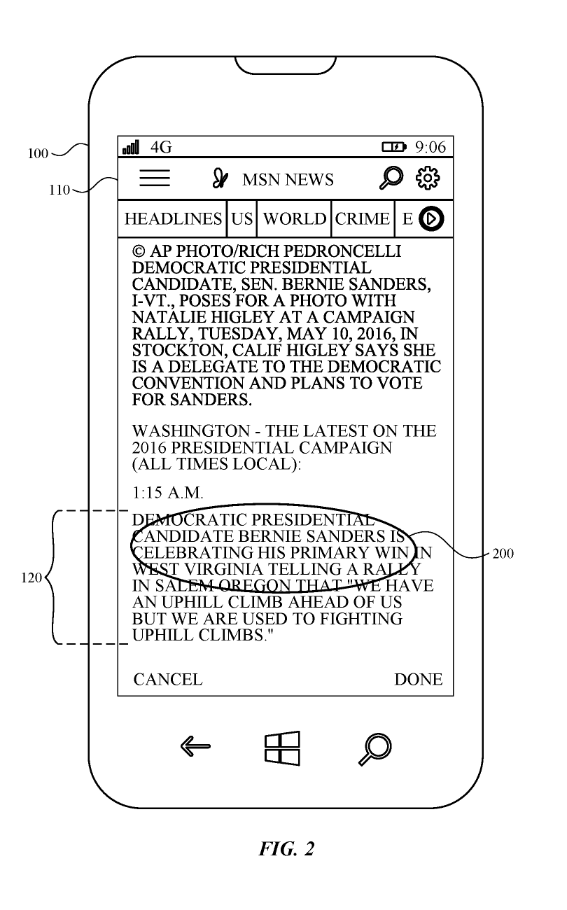

For example and turning to FIG. 2, a user may provide touch input to the display 110 of the electronic device 100 to draw or place a visual indicator 200 around a subset of content 120 she wishes to share. The visual indicator 200 may signify or otherwise identify a region of interest of the user. Although the visual indicator 200 shown in FIG. 2 has a circular shape, the visual indicator 200 may be a square, a rectangle or other such shape.

In other implementations, the visual indicator 200 may be a highlight (e.g., highlighted text), different colored text, or any other visual indicator that would notify a user that a particular subset of content within the displayed content 120 has been selected.

In some instances, as a user draws or otherwise provides input that results in the visual indicator 200 being provided on the display 110, the displayed content 120 may be scrolled up or down. For example, in some instances, if a user wants to share a particular sentence or phrase of the displayed content 120, a portion of the sentence or phrase may not currently be shown on the display 110. Accordingly, as the user provides the input for the visual indicator 200, the page (e.g., the webpage or user interface on which the content is displayed) may be scrolled up or down as the user provides the input.

Although touch input is specifically mentioned, the visual indicator 200 may be provided by a combination of force input and touch input. In other implementations, a mouse, a track pad, a stylus or any other input device may be used to select or otherwise indicate a subset of content that the user wants to share.

Once the visual indicator 200 is provided on the display, the user may change a position, a size and/or the shape of the visual indicator 200. This may be accomplished by selecting the visual indicator 200, or a portion of the visual indicator 200, and moving and/or resizing it. In addition, the user may simply redraw the visual indicator 200 around the text of the content the user wants to share.

As shown in FIG. 2, the visual indicator 200 may partially surround different text portions of the subset of content 120. In some embodiments, the visual indicator 200 may be used to determine a starting point of the content and an ending point of the content that is to be shared.

In order to determine the starting point and the ending point of the selected content, the displayed content 120 surrounded by the visual indicator 200, along with the neighboring content (e.g., the content that is outside the boundary of the visual indicator 200) and/or any images or pictures included with the content, is analyzed, based on a set of rules, to determine the context of the selected content.

The rules may include determining the grammar of a prominent word, phrase or sentence contained within the visual indicator 200. Analyzing any image or picture that may be included or otherwise associated with the selected content to determine the context of the selected content. The rules may also include determining the position of the visual indicator 200 with respect to complete sentences, words or phrases to determine prominent words, phrases or sentences within the boundaries of the visual indicator.

In other embodiments, the rules may include determining the punctuation of the selected content to determine what parts of the content the user wants to share. In yet another implementation, when a sentence, word or phrase falls outside the boundaries of the visual indicator 200, the rules may state that the entire sentence, word or phrase will not be included in the shared content.

For example and as shown in FIG. 2, the position of the visual indicator 200 may be analyzed with respect to the displayed content 120. Based on this analysis, it may be determined that the desired portion of content to be shared begins with the word “Democratic.” However, the visual indicator 200 also includes the phrases “telling a rally” and “Salem Oreg. that we.” If the content to be shared included one or both of these phrases as an ending point, the shared content would be incomplete.

Accordingly, the context of the selected content may be analyzed to determine a suitable ending point for the selected content. For example, it may be determined, based on the context of the circled portion of the content, that the user does not want to include any portion of the text beyond the quotation mark as most of the quoted text falls outside the boundary of the visual indicator 200.

However, if the selected content terminated with “in Salem Oreg. that,” the selected content would be incomplete and not have any meaning. Accordingly, it may be determined that the user wants the shared content to end after the phrase “West Virginia” as that is the most logical ending point of the sentence contained within the visual indicator 200.

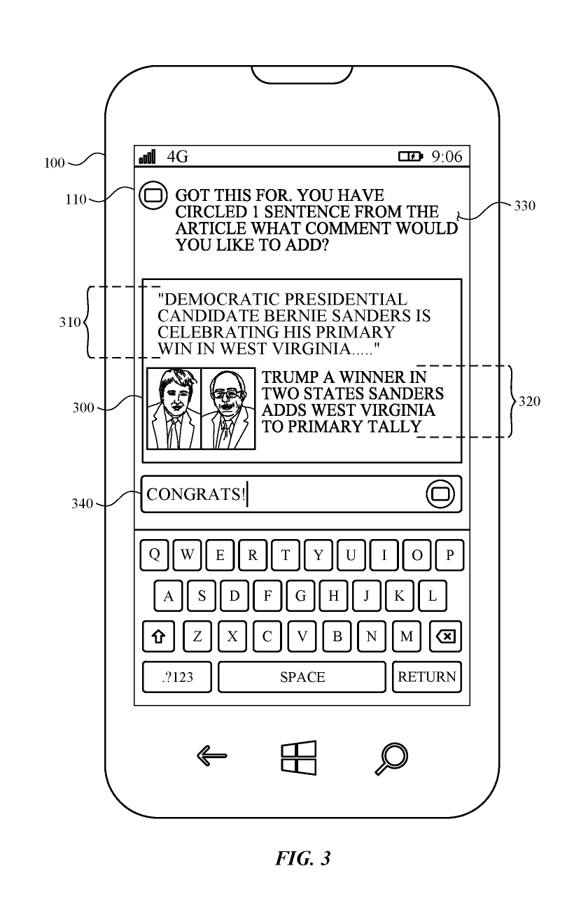

Referring to FIG. 3, once the determination described above is complete, a content card 300 containing the determined content 310 is provided and output on the display 110. If the determined content 310 on the content card 300 is not correct, the user may discard the content card 300 and provide another visual indicator 200 on the displayed content 120.

In some embodiments, the content card 300 may also include additional information 320 about the displayed content 120. For example, the additional information 320 may be an image associated with the content, a headline of an article from which the determined content 310 was taken, another subset of content (e.g., a subset of content different from the determined content 310) taken from the original displayed content 120 and so on. In some embodiments, the additional information 320 may be automatically generated or otherwise preselected based on one or more identifiers contained in the original displayed content 120.

A generated message 330 may also be displayed along with the content card 300. The generated message 330 may inform the user of how many paragraphs, sentences, words and/or phrases the user has selected for sharing (e.g., using the visual indicator 200 described above). The generated message 330 may also inform the user that additional content may be added to the content card 300.

For example, a text box 340 may be provided along with the content card 300 that enables a user to provide text, images, or other content that may be related to or otherwise associated with the determined content 310. Once the additional content has been provided, the additional content may be added to or otherwise associated with the content card 300.

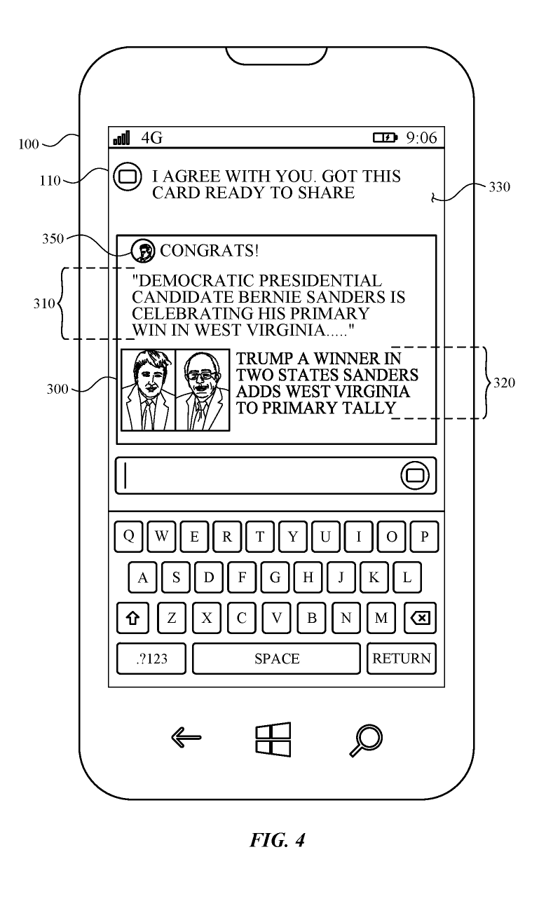

For example and referring to FIG. 4, the additional content 350 “Congrats!” that was provided in the text box 340 has been added to the content card 300. As also shown in FIG. 4, once the content card 300 with the additional content 350 has been created, the generated message 330 may indicate that the content card 300 is ready to share. In some embodiments, the content card 300 is an image that is generated to include the determined content 310, any additional information 320 and any additional content 350.

Once the content card 300 with the additional content 350 has been generated, the content card 300 may be electronically shared. In some embodiments, the content card 300 may be shared in a first medium or a second medium. The particular medium may be selected based on received input.

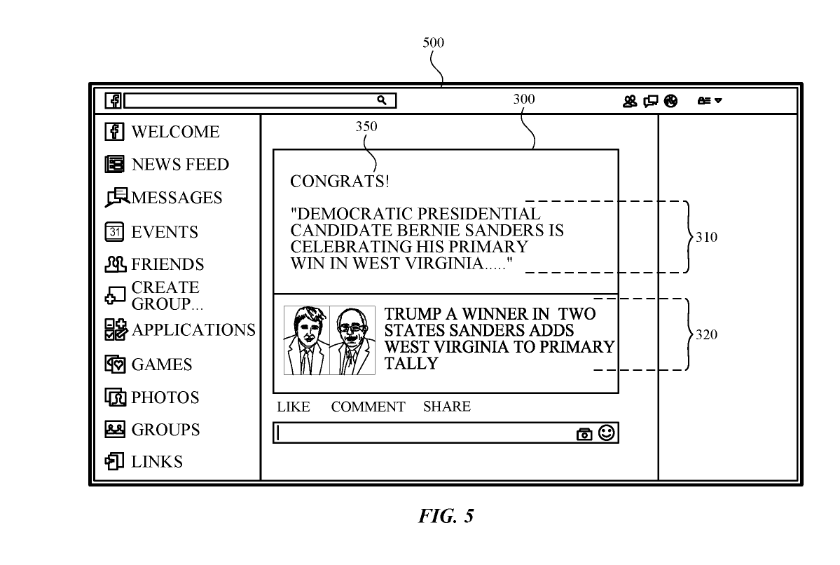

For example, and turning to FIG. 5, the content card 300 may be shared on a social media site 500. In this instance, once the content card 300 is created, an option may be presented to the user to select the first medium. In other embodiments, the content card 300 may be shared via an electronic message such as, for example, a text message, a picture message, a video message, an email message and so on. Like the social media example, once the content card 300 has been created, an option may be presented that enables a user to provide input that indicates that the content card 300 should be shared via a second medium.

In some implementations, the text and/or any images provided on the content card 300 may be shared in lieu of the content card 300. For example, if the user wants to share content card 300 via a text message, the text of the content card 300 may be transmitted without sending the actual content card 300.

Once the content card 300 has been shared on the social media site 500 or via electronic message, selection of the content card 300, or a portion of the content card (e.g., additional content 350, the determined content 310, or the additional information 320) may cause the original content (e.g., the news article from which the determined content 310 was taken) to be provided on a display of the receiving electronic device.

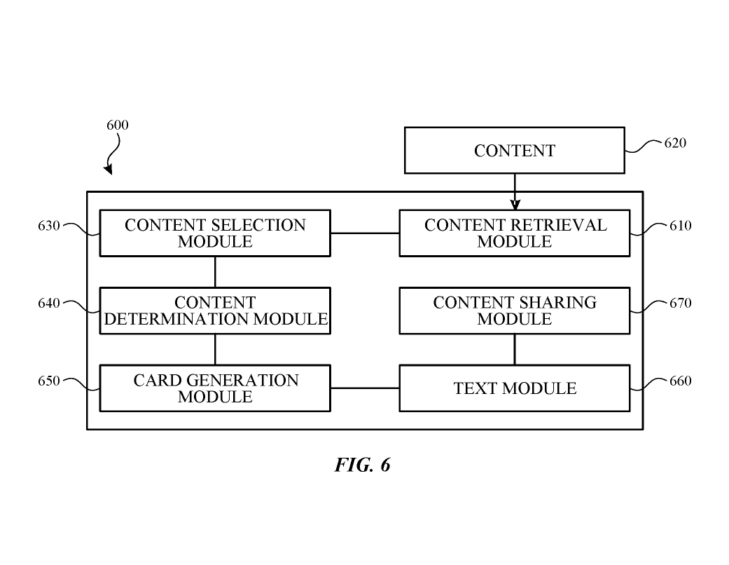

FIG. 6 illustrates example components of an electronic device 600 that may be used to share selected content. The components described below may be used with the electronic device 100 shown and described above. Further, the components may be used to generate and share a content card, such as content card 300 described above. Although different modules are shown as separate components, one or more modules may be combined. Further, additional modules may be added or some modules may be omitted.

The electronic device 600 may include a content retrieval module 610 that retrieves content 620. The content 620 may be any content that is available over a network connection such as, for example, the internet. The content 620 may be news articles, videos, images, books, magazine articles and so on.

In some embodiments, the content retrieval module 610 may acquire content based on, for example, a browsing or viewing history of the user. For example, if the user views content corresponding to the Seattle Seahawks, the content retrieval module 610 may search for content related to the Seattle Seahawks and provide it to the user. In other implementations, the content retrieval module 610 may select content 620 based on what is trending or currently popular and provide the content 620 to the user. In yet another implementation, the content 620 that is retrieved may be similar to content that the user has previously shared.

Once the content 620 has been gathered, a user may view one or more particular content items. For example, an application that is executing on the electronic device 600 may display the gathered content 620 on a user interface. While viewing a particular content item, a user may provide input to the electronic device 600 to generate a visual indicator that surrounds or identifies a region of interest of the user. More specifically, a content selection module 630 may be used to draw or otherwise indicate, using a visual indicator, a subset of content the user wishes to share.

Once the visual indicator has been generated, a content determination module 640 determines, based on the region of interest, the content the user wants to share. For example, the content determination module 640 may determine a starting point and an ending point for the selected content or otherwise identify a portion of the content that the user wants to share. That is, the content determination module may be analyze which words, sentences, phrases or paragraphs have been selected using the visual indicator and determine the amount of content to be included on a content card.

In making this determination, the content determination module 640 may analyze the context of the content contained in the visual indicator, the grammar of the selected text (and any surrounding text), a prominent word, phrase, sentence or paragraph contained within the visual indicator, any image or picture that may be included or otherwise associated with the selected content, the position of the visual indicator with respect to complete sentences, words or phrases, the punctuation of the selected content and so on.

The electronic device 600 may also include a card generation module 650. The card generation module 650 generates a content card, such as, for example, content card 300 described above. The content card may include the determined content from the content determination module 640. In some embodiments, the content card is an image generated by the card generation module 650. The image may then be electronically shared such as described below.

A text module 660 may be used to add additional text, such as comments, images, video recordings and the like, to the content card. For example, the user interface that displays the content card may include an input mechanism, such as a keyboard, that enables a user to add additional content.

Once the additional content has been added, the content card is finalized and may be electronically shared. More specifically, the electronic device 600 may include a content sharing module 670 enables the content to be electronically shared. For example, the content sharing module 670 may be used to provide or otherwise post the content card on a social media account, an email message, a text message, or any other form of electronic communication. In some instances, once the content card is generated an approved, a share button on the user interface may be used to select and post the content card on a social media site. The share button may also be used to select and transmit the content card, or the text contained in the content card, via an electronic communication.

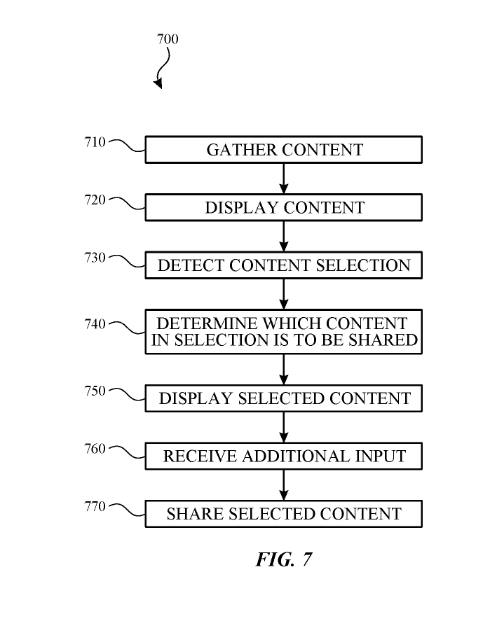

FIG. 7 illustrates an example method 700 for sharing content. The method 700 may be used to share a content card such as described above and/or any content contained on the content card. The method 700 may be used by an application executing on an electronic device such as the electronic device 100 described above. Additionally, the method 700, or portions of the method 700, may be executed by one or more modules described above.

Method 700 begins at operation 710 in which content is gathered. In some embodiments, the content is available on the internet and is gathered by a content retrieval module. The gathered content may be based on any number of factors including, trending articles, books, news stories, music, videos and the like, previously shared content, content that was previously accessed by the user, and so on.

Once the content has been gathered, flow proceeds to operation 720 and the gathered content is displayed. In some embodiments, the content may be provided on a user interface of an application that gathers content. In another embodiment, the gathered content may be provided on a display of the electronic device.

Flow proceeds to operation 730 and a processor of the electronic device detects a selection of content. For example, once the content has been displayed, a user may select a subset of content using the various input methods described above. In some embodiments, a visual indicator is provided on or over the selected content to show the user which content they have selected.

Flow then proceeds to operation 740 and a determination is made as to which content in the selected area (e.g., the area covered by the visual indicator) is to be shared. In some embodiments, the determination may be based on a set of rules such as described above. For example, the rules may include determining which words, phrases or paragraphs to include based on the position of the visual indicator, the context of the selected content, punctuation associated with the selected content, images associated with the selected content and so on.

In operation 750, the selected content is provided to the user. The content may be provided to the user on a content card. The content card may be an image of the selected content. The content card may also have additional information about the content such as, for example, an image associated with the content, a title of the content and so on.

The content card is provided to the user to enable the user to make sure that the selected content includes all the text (or other content) the user wants to share. If all of the text is not on the content card, or if additional text is included on the content card, the user may edit the selected content. Editing may include moving the visual indicator to a new position on the content page, changing a size and/or a shape of the visual indicator, redrawing the visual indicator and so on.

Once the user has determined that the selected content is correct, the user may provide additional input 760 to the content card. For example, a content entry field, such as a text box, may be provided on the user interface of the electronic device to enable a user to add text, images, videos and the like to the content card.

Flow then proceeds to operation 770 and the content card is electronically shared. In some embodiments, the content card may be shared in a first medium or a second medium. For example, the content card, or the content contained in the content card may be provided to a social media site, sent via electronic message and so on.

In some embodiments, the application that generated the content card may automatically send, provide, or otherwise post the content card to a desired social media site in response to a first received input. The application may also automatically send the content card, or the content contained in the content card, to a recipient based on a second received input. For example, the application may include a share button that when selected, provides the user an option as to which social media account the content card will be posted on, the type of electronic message that will be used to share the content and/or the content card, the desired recipient and so on.

In some embodiments, any text, images or other content contained on the content card may be provided to a messaging application and shared with one or more other users. In such instances, although the content is shared, the content card itself may not be shared. For example, if the content card is selected to be transmitted over a text message, the text of the content card, and not the image of the content card, may be sent via the text message.

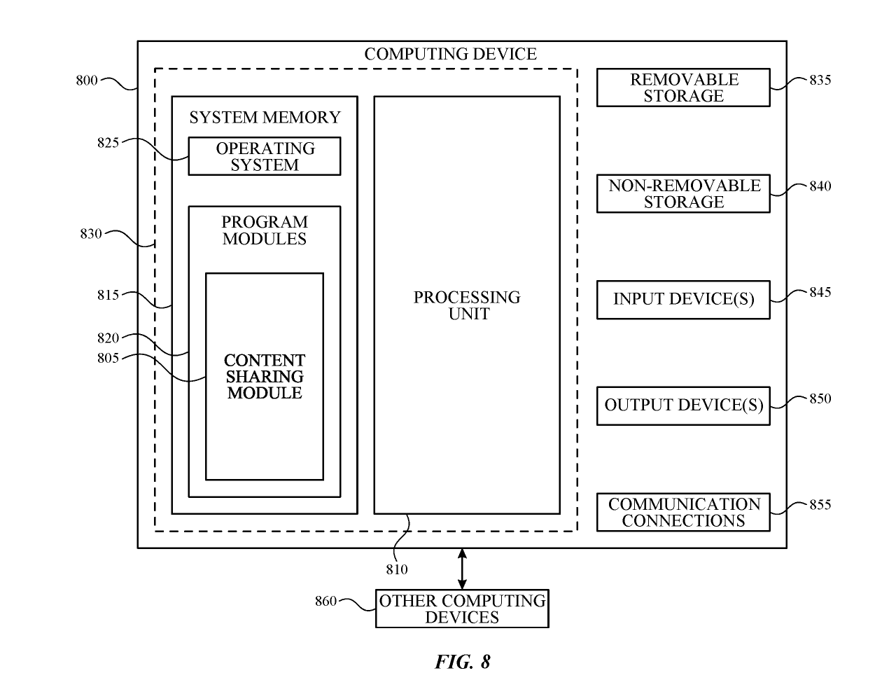

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of electronic device configurations that may be utilized for practicing aspects of the disclosure, as described herein.

FIG. 8 is a block diagram illustrating physical components (e.g., hardware) of an electronic device 800 with which aspects of the disclosure may be practiced. The components of the electronic device 800 described below may have computer executable instructions for causing a content sharing module 805 to share generate and share content cards such as described above and/or execute the method 700 described herein.

In a basic configuration, the electronic device 800 may include at least one processing unit 810 and a system memory 815. Depending on the configuration and type of electronic device, the system memory 815 may comprise, but is not limited to, volatile storage (e.g., random access memory), non-volatile storage (e.g., read-only memory), flash memory, or any combination of such memories. The system memory 815 may include an operating system 825 and one or more program modules 820 suitable for applications that display content, select content and share content, or otherwise navigate through a user interface such as described herein.

The operating system 825, for example, may be suitable for controlling the operation of the electronic device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 830.

The electronic device 800 may have additional features or functionality. For example, the electronic device 800 may also include additional data storage devices (removable and/or non-removable) such as, for example, magnetic disks, optical disks, or tape. Such additional storage is illustrated in FIG. 8 by a removable storage device 835 and a non-removable storage device 840.

As stated above, a number of program modules and data files may be stored in the system memory 815. While executing on the processing unit 810, the program modules 820 (e.g., the content sharing module 805) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit.

When operating via an SOC, the functionality, described herein, with respect to the capability of client to switch protocols may be operated via application-specific logic integrated with other components of the electronic device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The electronic device 800 may also have one or more input device(s) 845 such as a keyboard, a trackpad, a mouse, a pen, a sound or voice input device, a touch, force and/or swipe input device, etc. The output device(s) 850 such as a display, speakers, a printer, etc. may also be included. The aforementioned devices are examples and others may be used. The electronic device 800 may include one or more communication connections 855 allowing communications with other electronic devices 860. Examples of suitable communication connections 855 include, but are not limited to, radio frequency (RF) transmitter, receiver, and/or transceiver circuitry; universal serial bus (USB), parallel, and/or serial ports.

The term computer-readable media as used herein may include computer storage media. Computer storage media may include volatile and nonvolatile, removable and non-removable media implemented in any method or technology for storage of information, such as computer readable instructions, data structures, or program modules.

The system memory 815, the removable storage device 835, and the non removable storage device 840 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the electronic device 800. Any such computer storage media may be part of the electronic device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

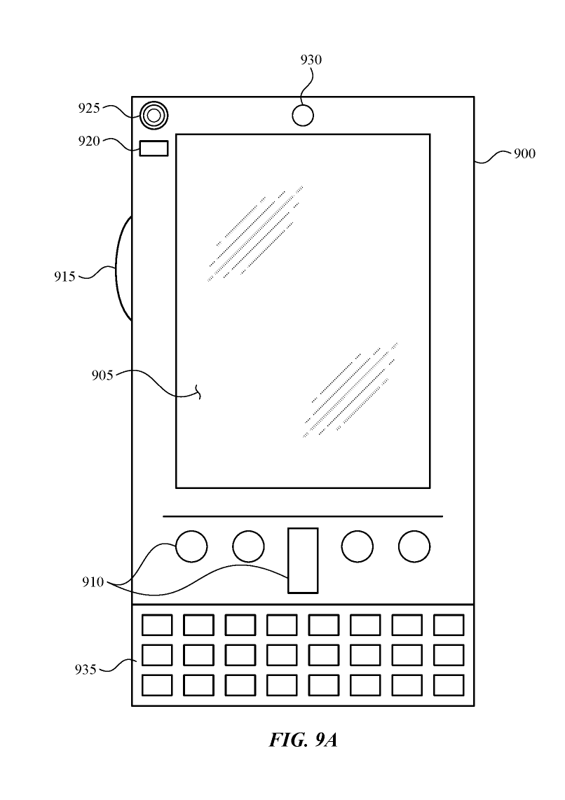

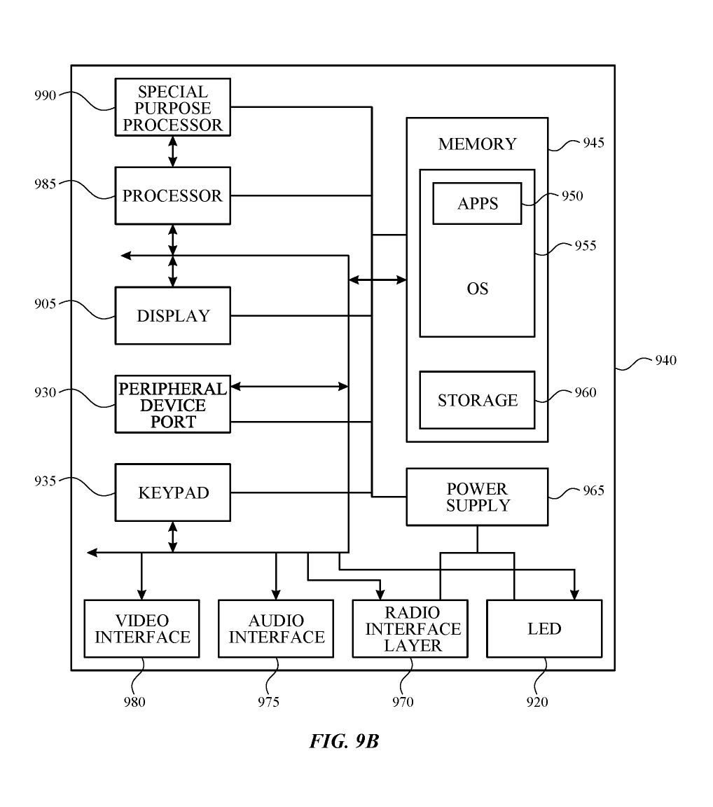

FIGS. 9A and 9B illustrate a mobile electronic device 900, for example, a mobile telephone, a smart phone, wearable computer (such as a smart watch), a tablet computer, a laptop computer, and the like, with which embodiments of the disclosure may be practiced. With reference to FIG. 9A, one aspect of a mobile electronic device 900 for implementing the aspects is illustrated.

In a basic configuration, the mobile electronic device 900 is a handheld computer having both input elements and output elements. The mobile electronic device 900 typically includes a display 905 and one or more input buttons 910 that allow the user to enter information into the mobile electronic device 900. The display 905 of the mobile electronic device 900 may also function as an input device (e.g., a display that accepts touch and/or force input).

If included, an optional side input element 915 allows further user input. The side input element 915 may be a rotary switch, a button, or any other type of manual input element. In alternative aspects, mobile electronic device 900 may incorporate more or less input elements. For example, the display 905 may not be a touch screen in some embodiments. In yet another alternative embodiment, the mobile electronic device 900 is a portable phone system, such as a cellular phone. The mobile electronic device 900 may also include an optional keypad 935. Optional keypad 935 may be a physical keypad or a “soft” keypad generated on the touch screen display.

In various embodiments, the output elements include the display 905 for showing a graphical user interface (GUI), a visual indicator 920 (e.g., a light emitting diode), and/or an audio transducer 925 (e.g., a speaker). In some aspects, the mobile electronic device 900 incorporates a vibration transducer for providing the user with tactile feedback. In yet another aspect, the mobile electronic device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile electronic device 900. That is, the mobile electronic device 900 can incorporate a system (e.g., an architecture) 940 to implement some aspects. In one embodiment, the system 940 is implemented as a “smart phone” capable of running one or more applications (e.g., browser, e-mail, calendaring, contact managers, messaging clients, games, media clients/players, content selection and sharing applications and so on). In some aspects, the system 940 is integrated as an electronic device, such as an integrated personal digital assistant (PDA) and wireless phone.

One or more application programs 950 may be loaded into the memory 945 and run on or in association with the operating system 955. Examples of the application programs include phone dialer programs, e-mail programs, personal information management (PIM) programs, word processing programs, spreadsheet programs, Internet browser programs, messaging programs, and so forth.

The system 940 also includes a non-volatile storage area 960 within the memory 945. The non-volatile storage area 960 may be used to store persistent information that should not be lost if the system 940 is powered down.

The application programs 950 may use and store information in the non-volatile storage area 960, such as email or other messages used by an email application, and the like. A synchronization application (not shown) also resides on the system 940 and is programmed to interact with a corresponding synchronization application resident on a host computer to keep the information stored in the non-volatile storage area 960 synchronized with corresponding information stored at the host computer.

The system 940 has a power supply 965, which may be implemented as one or more batteries. The power supply 965 may further include an external power source, such as an AC adapter or a powered docking cradle that supplements or recharges the batteries.

The system 940 may also include a radio interface layer 970 that performs the function of transmitting and receiving radio frequency communications. The radio interface layer 970 facilitates wireless connectivity between the system 940 and the “outside world,” via a communications carrier or service provider. Transmissions to and from the radio interface layer 970 are conducted under control of the operating system 955. In other words, communications received by the radio interface layer 970 may be disseminated to the application programs 950 via the operating system 955, and vice versa.

The visual indicator 920 may be used to provide visual notifications, and/or an audio interface 975 may be used for producing audible notifications via an audio transducer (e.g., audio transducer 925 illustrated in FIG. 9A). In the illustrated embodiment, the visual indicator 920 is a light emitting diode (LED) and the audio transducer 925 may be a speaker. These devices may be directly coupled to the power supply 965 so that when activated, they remain on for a duration dictated by the notification mechanism even though the processor 985 and other components might shut down for conserving battery power. The LED may be programmed to remain on indefinitely until the user takes action to indicate the powered-on status of the device.

The audio interface 975 is used to provide audible signals to and receive audible signals from the user. For example, in addition to being coupled to the audio transducer 925, the audio interface 975 may also be coupled to a microphone to receive audible input, such as to facilitate a telephone conversation. In accordance with embodiments of the present disclosure, the microphone may also serve as an audio sensor to facilitate control of notifications, as will be described below.

The system 940 may further include a video interface 980 that enables an operation of peripheral device 930 (e.g., on-board camera) to record still images, video stream, and the like.

A mobile electronic device 900 implementing the system 940 may have additional features or functionality. For example, the mobile electronic device 900 may also include additional data storage devices (removable and/or non-removable) such as, magnetic disks, optical disks, or tape. Such additional storage is illustrated in FIG. 9B by the non-volatile storage area 960.

Data/information generated or captured by the mobile electronic device 900 and stored via the system 940 may be stored locally on the mobile electronic device 900, as described above, or the data may be stored on any number of storage media that may be accessed by the device via the radio interface layer 970 or via a wired connection between the mobile electronic device 900 and a separate electronic device associated with the mobile electronic device 900, for example, a server computer in a distributed computing network, such as the Internet. As should be appreciated such data/information may be accessed via the mobile electronic device 900 via the radio interface layer 970 or via a distributed computing network. Similarly, such data/information may be readily transferred between electronic devices for storage and use according to well-known data/information transfer and storage means, including electronic mail and collaborative data/information sharing systems.

As should be appreciated, FIG. 9A and FIG. 9B are described for purposes of illustrating the present methods and systems and is not intended to limit the disclosure to a particular sequence of steps or a particular combination of hardware or software components.

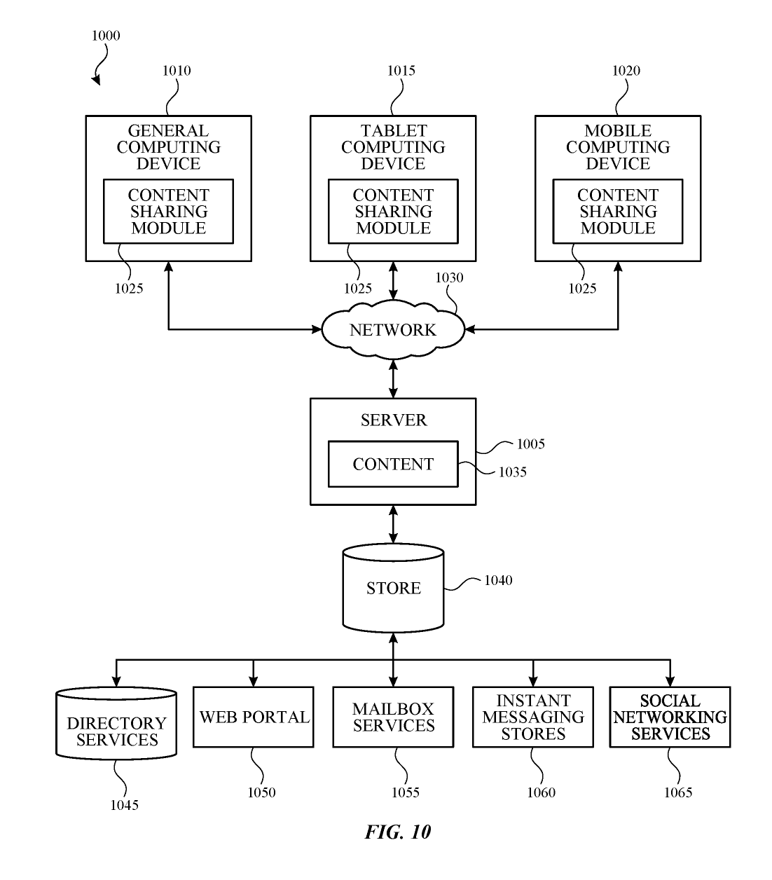

FIG. 10 illustrates one aspect of the architecture of a system 1000 for processing and or sharing content or other data received at a computing system from a remote source, such as a general electronic device 1010 (e.g., personal computer), tablet electronic device 1015, or mobile electronic device 1020, as described above. Content displayed at server device 1005, such as, for example, a generated content card, may be stored in different communication channels or other storage types.

For example, various types on content may be stored by or transmitted to a directory service 1045, a web portal 1050, mailbox services 1055, instant messaging stores 1060, or social networking services 1065.

The content sharing module 1025 may be employed by a client that communicates with server device 1005 to retrieve content 1035 and share generated content cards. For example, the server device 1005 may provide data to and from a client electronic device such as a general electronic device 1010, a tablet electronic device 1015 and/or a mobile electronic device 1020 (e.g., a smart phone) through a network 1030.

By way of example, the aspects described above may be embodied in a general electronic device 1010 (e.g., personal computer), a tablet electronic device 1015 and/or a mobile electronic device 1020 (e.g., a smart phone). Any of these embodiments of the electronic devices may obtain content from or provide data to the store 1040.

As should be appreciated, FIG. 10 is described for purposes of illustrating the present methods and systems and is not intended to limit the disclosure to a particular sequence of steps or a particular combination of hardware or software components.

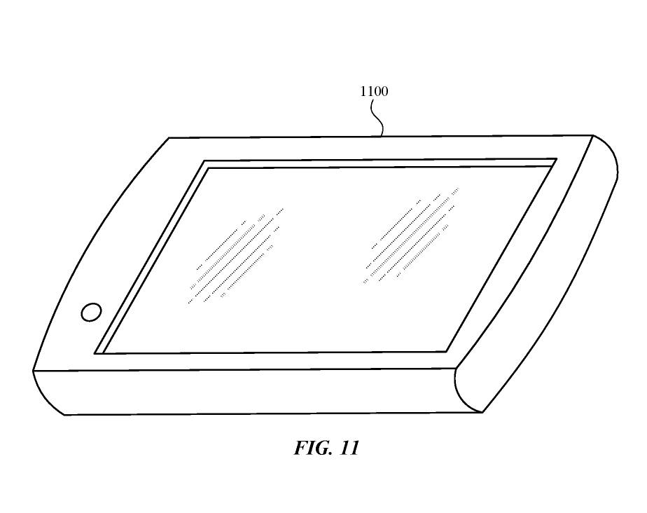

FIG. 11 illustrates an exemplary tablet electronic device 1100 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board electronic device displays or via remote display units associated with one or more electronic devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated electronic device is equipped with detection (e.g., camera) functionality for capturing and interpreting user gestures for controlling the functionality of the electronic device, and the like.

As should be appreciated, FIG. 11 is described for purposes of illustrating the present methods and systems and is not intended to limit the disclosure to a particular sequence of steps or a particular combination of hardware or software components.

Among other examples, the present disclosure describes a method for sharing content comprising: receiving input for selecting a subset of content from displayed content; displaying a visual indicator representing the selection of the subset of content; determining, based on one or more rules associated with the visual indicator, an amount of content, from the subset of content, that is to be shared; generating an output that includes the amount of content; providing a user interface that enables additional content to be added to the output; determining, based on a received input, whether the output will be electronically shared in a first medium or a second medium; providing the output to the first medium when a first input is received; and providing the output to the second medium when a second input is received. In further examples, a position of the visual indicator may be changed to change the selection of the subset of content. In further examples, a size of the visual indicator may be changed to change the selection of the subset of content. In further examples, the first medium is a social medial site. In further examples, the second medium is an electronic message. In further examples, the additional content is text content that is associated with the subset of content. In further examples, the output is an image that includes the amount of content and the additional content.

Further aspects disclosed herein provide a system comprising: a processor; and a memory for storing instructions which, when executed by the processor, performs a method for displaying content, comprising: detecting a selection of content; displaying a visual indicator associated with the selected content; determining a starting point of the selected content and an ending point of the selected content based, at least in part, on the visual indicator; and preparing the selected content for display. In further examples, the system further comprises instructions for providing an input area for adding additional content to the prepared selected content. In further examples, the visual indicator is a shape that at least partially surrounds the selected content. In further examples, the preparing the selected content for display comprises displaying the selected content on a card. In further examples, the preparing the selected content for display comprises displaying additional content, along with the selected content, on a card. In further examples, determining the starting point of the selected content and the ending point of the selected content comprises determining one or more tags associated with the selected content. In further examples, preparing the selected content for display comprises generating a preview of the selected content.

Additional aspects disclosed herein describe a computer-readable storage medium comprising computer-executable instructions which, when executed by a processor, performs a method for sharing content, comprising: displaying content on a display of an electronic device; determining a region of interest of the content based, at least in part, on a detected input; determining, based at least in part, on the region of interest, content that is to be shared; generating a content card having the shared content; enabling additional content to be added to the content card; and enabling the content card to be shared. In further examples, enabling the content card to be shared comprises enabling at least one of the content and the additional content to be shared. In further examples, the determined region of interest is displayed as a visual indicator. In further examples, the detected input is touch input. In further examples, enabling the content card to be shared comprises sending the content card to a social media account. In further examples, the content that is displayed is based, at least in part, on one or more of previously retrieved content or previously shared content.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A method for sharing content, comprising:
receiving input for selecting a subset of content from displayed content;
displaying a visual indicator representing the selection of the subset of content;
determining, based on one or more rules associated with the visual indicator, an amount of content, from the subset of content, that is to be shared;
generating an output that includes the amount of content;
providing a user interface that enables additional content to be added to the output;
determining, based on a received input, whether the output will be electronically shared in a first medium or a second medium;
providing the output to the first medium when a first input is received; and
providing the output to the second medium when a second input is received.

2. The method of claim 1, further comprising changing a position of the visual indicator to change the selection of the subset of content.

3. The method of claim 1, further comprising changing a size of the visual indicator to change the selection of the subset of content.

4. The method of claim 1, wherein the first medium is a social medial site.

5. The method of claim 1, wherein the second medium is an electronic message.

6. The method of claim 1, wherein the additional content is text content that is associated with the subset of content.

7. The method of claim 1, wherein the output is an image that includes the amount of content and the additional content.

8. A system, comprising:
a processor; and
a memory for storing instructions which, when executed by the processor, performs a method for displaying content, comprising:
detecting a selection of content;
displaying a visual indicator associated with the selected content;
determining a starting point of the selected content and an ending point of the selected content based, at least in part, on the visual indicator; and
preparing the selected content for display.

9. The system of claim 8, further comprising instructions for providing an input area for adding additional content to the prepared selected content.

10. The system of claim 8, wherein the visual indicator is a shape that at least partially surrounds the selected content.

11. The system of claim 8, wherein the preparing the selected content for display comprises displaying the selected content on a card.

12. The system of claim 8, wherein the preparing the selected content for display comprises displaying additional content, along with the selected content, on a card.

13. The system of claim 8, wherein determining the starting point of the selected content and the ending point of the selected content comprises determining one or more tags associated with the selected content.

14. The system of claim 8, wherein preparing the selected content for display comprises generating a preview of the selected content.

15. A computer-readable storage medium comprising computer-executable instructions which, when executed by a processor, performs a method for sharing content, comprising:
displaying content on a display of an electronic device;
determining a region of interest of the content based, at least in part, on a detected input;
determining, based at least in part, on the region of interest, content that is to be shared;
generating a content card having the shared content;
enabling additional content to be added to the content card; and
enabling the content card to be shared.
